(19) United States
(12) Patent Application Publication
(10) Pub. No.: US 2022/0258824 A1
(43) Pub. Date: Aug. 18, 2022

(54) ELECTRIC VEHICLES, SYSTEMS, AND METHODS THEREOF

(71) Applicant: Boogie Bikes LLC, Waldo, WI (US)

(72) Inventors: Dustin Veldkamp, Waldo, WI (US); Lee Veldkamp, Sheboygan, WI (US); Ardean Veldkamp, Waldo, WI (US); Dean Dumez, Sheboygan, WI (US); Thomas David VanDerPuy, Sheboygan, WI (US)

(73) Assignee: Boogie Bikes LLC, Waldo, WI (US)

(21) Appl. No.: 17/672,223

(22) Filed: Feb. 15, 2022

Related U.S. Application Data
(60) Provisional application No. 63/149,919, filed on Feb. 16, 2021.

(51) Int. Cl. B62J 45/20; B62M 6/50

(52) U.S. Cl. CPC B62J 45/20; B62M 6/50

(57) ABSTRACT

A bicycle is for use by an operator, and the bicycle includes a frame having a front wheel and a rear wheel rotatably coupled thereto. An electric motor is coupled to the frame and configured to receive electrical energy from an energy storage device and drive at least one of the wheels to thereby assist the operator in propelling the bicycle. A wind sensor is configured to sense winds acting on the bicycle and generate a measured wind sensor input. A control system is operable to control a power output of the electric motor. The control system receives the measured wind sensor input and controls the power output of the electric motor based on the wind sensor input.

### CROSS-REFERENCE TO RELATED APPLICATION

The present disclosure is based on and claims priority to U.S. Provisional Patent Application No. 63/149,919 filed Feb. 16, 2021, the disclosure of which is incorporated herein by reference.

### FIELD

The present disclosure relates to electric vehicles, and specifically to electric power compensating and management systems and methods for electric vehicles.

### BACKGROUND

This Background is intended to introduce various aspects of the art, which may be associated with the present disclosure to thereby assist in providing a framework to facilitate a better understanding of particular aspects of the present disclosure. Accordingly, it should be understood that this Background should be read in this light, and not necessarily as admissions of prior art.

Electric vehicles such as electric bicycles, scooters, automobiles, and mopeds, enable an operator to transport himself or herself to a desired destination. The vehicles are propelled by one or more systems such as a manual power generating drive system (e.g., a bicycle with pedals and sprockets that permit the operator to propel the bike by pedaling) and/or an electric power drive system (e.g., an electric motor coupled to a rear axle of a scooter such that the axle is electrically rotated and the scooter is propelled forward). Thus, some vehicles are propelled in-part or completely by on-board electric power systems to thereby minimize or eliminate effort needed from the operator to propel the vehicle.

The vehicles are used in a variety of applications such as commuting in and to cities, moving along rural roads, towing, transportation of goods, and/or recreational trail riding. The vehicles can also be used in different climates and in the presence of environmental factors, such as rain, snow, and wind.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a bicycle is for use by an operator. The bicycle includes a frame having a front wheel and a rear wheel rotatably coupled thereto. A manual drive system with a pedal and crank assembly is configured to be engaged by the operator such that the operator can rotate the rear wheel and propel the bicycle. An electric motor is coupled to the frame and configured to receive electrical energy from an energy storage device and drive at least one of the wheels to thereby assist the operator in propelling the bicycle. A wind sensor is configured to sense winds acting on the bicycle and generate a measured wind sensor input. A control system is operable to control a power output of the electric motor. The control controller receives the measured wind sensor input and controls the power output of the electric motor based at least in part on the wind sensor input.

In certain examples, a vehicle is for use by an operator. The vehicle has a frame with a front wheel and a rear wheel rotatably coupled thereto. An electric motor is coupled to the frame and is configured to receive electrical energy from an energy storage device and provide a power output to drive one of the front or back wheels to propel the vehicle. A wind sensor is configured to sense winds acting on the vehicle and generate a measured wind sensor input. A control system is operable to control a power output of the electric motor, and the control system receives the measured wind sensor input and controls the power output of the electric motor based at least in part on the measured wind sensor input.

In certain examples, a method for controlling an electric motor on a vehicle designed to be used by an operator can include the steps of providing a control system operable to control a power output of the electric motor of the vehicle and receiving, via an operator input device, a speed setting input at the control system from the operator of the vehicle that corresponds to a desired speed of the vehicle. The example method can further include the steps of sensing mass of the operator and generating a measured mass sensor input that is sent to the control system, sensing wind acting on the vehicle and generating a measured wind sensor input that is sent to the control system, processing, with the control system, the measured mass sensor input and the measured wind sensor input to determine a desired power output of the motor to maintain the vehicle at the desired speed of the vehicle inputted into the operator input device, and operating the motor, with the control system, at the desired power output.

In certain examples, a bicycle for use by an operator includes a frame having a front wheel and a rear wheel rotatably coupled thereto. A manual drive system with a pedal and crank assembly is included that the operator engages to thereby rotate at least one wheel and propel the bicycle. An electric motor coupled to the frame and configured to receive electrical energy from an energy storage device and drive at least one of the wheels to thereby assist the operator in propelling the bicycle or resist rotation of at least one of the wheels to thereby increase resistance the operator experiences while pedaling the pedal and crank assembly. A mass sensor is configured to sense a mass of the operator and generate a measured mass sensor input, a cadence sensor is configured to sense a cadence of the pedal and crank assembly and generate a measured cadence sensor input, and an operator input device is configured to receive an operator input from the operator that corresponds to a desired calorie expenditure. A control system that receives the measured mass sensor input, the measured cadence sensor input, and the operator input and determines a power output of the electric motor to match the desired calorie expenditure of the operator.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 is a side view of an example bicycle according to the present disclosure.

FIG. 2 is a schematic diagram of an example control system according to the present disclosure.

FIG. 3 is an example method for controlling an example bicycle.

FIG. 4 is another example method for controlling an example bicycle.

FIG. 5 is another example method for controlling an example bicycle.

FIG. 6 is an example diagram of an example PWM generation circuit.

FIG. 7 depicts Tables 1-6.

FIG. 8 depicts Tables 7-11.

FIG. 9 depicts another example method for controlling an example bicycle.

### DETAILED DESCRIPTION

The disclosure herein describes apparatuses, systems, and methods for electric vehicles that have an electric drive system that propels the vehicle. The present inventor recognized that during operation of the vehicle various operational factors impact the vehicle and the operation thereof. These operational factors can affect the operation of the vehicle, energy efficiency of the vehicle, and/or comfort of the operator. The number of operational factors can vary and include the slope or grade of the terrain the vehicle moves along, acceleration, the headwinds or tailwinds acting on the vehicle and/or operator, the manual power the operator generates while operating the vehicle, the weight of any towed vehicle, the sensed weight of the operator, and/or inputs from the operator (e.g., inputter weight of the operator). Accordingly, the present inventor has endeavored to develop the electric vehicles, systems, and methods described herein below that account for one or more operational factors such that the electrical power efficiency of the vehicle and the comfort of the operator is maintained or improved.

In addition, the present inventors have endeavored to develop improvements over known vehicles by accounting for one or more operational factors that affect operation of the vehicle. Accordingly, the apparatuses, systems, and methods described hereinbelow may advantageously provide a customized “smart ride” experience for the operator, adjust the power output of the motor compensate for a low-effort ride and/or smoother ride, and/or predict battery usage, life, and remaining charge. Furthermore, the vehicle can provide estimates on battery/charge life. In addition, the vehicle may more accurately calculate the energy exerted by the operator by factoring in the operational factors and thereby provide health and wellness metrics to the operator (e.g., accurate calorie count, workout data, personal goals/improvement).

Note that while the below description describes a bicycle, the features, and/or the components described hereinbelow with reference to the bicycle may be utilized with any type of vehicle such as mopeds, scooters, tractors, all-terrain vehicles, golf carts, boats paddle boats, water bicycles, kayaks, and automobiles such as cars, minivans, and trucks.

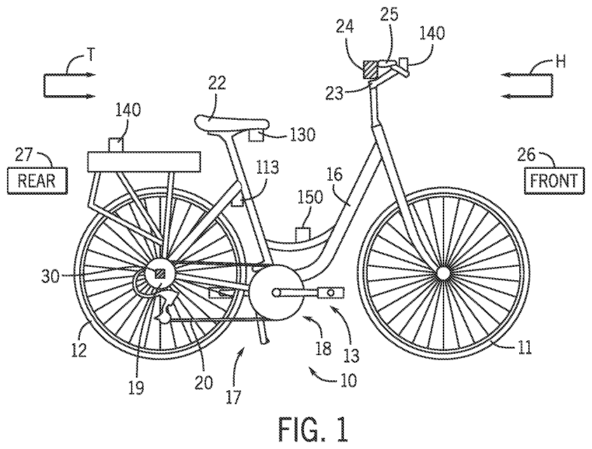

FIG. 1 depicts an example bicycle 10 of the present disclosure. The bicycle 10 generally has a front 26 and an opposite rear 27. The bicycle 10 includes a frame 16 and a pair of wheels, namely a front wheel 11 and a rear wheel 12. A pedal and crank assembly 13 for manually pedaling the bicycle 10 is coupled to the frame 16. A manual drive system 17 can include the pedal and crank assembly 13 and is coupled to the rear wheel 12 such that as the operator pedals, the drive system 17 rotates the rear wheel 12. The drive system 17 can further include a continuous belt (not shown) or a continuous chain 20 (described hereinbelow). The example drive system 17 depicted in FIG. 1 is an example chain drive system that includes a pedal sprocket set 18 having one or more toothed pedal sprockets mounted on a shaft of the pedal and crank assembly 13 and a rear wheel sprocket set 19 having one or more toothed sprockets mounted on a shaft about which the rear wheel 12 rotates. The continuous chain 20 engages the pedal sprocket set 18 and the rear wheel sprocket set 19 via known conventional gearing systems. During operation, the operator of the bicycle 10 engages the drive system 17 by applying pedaling forces to the pedal and crank assembly 13 to thereby rotate the pedal sprocket set 18 such that the chain 20 acts on and rotates the rear sprocket set 19 and the rear wheel 12. Thus, the bicycle 10 is propelled forward. Note that in certain examples, the drive system 17 can include a front wheel sprocket set (not shown) such that the front wheel sprocket set is coupled to the pedal sprocket set 18 via the chain 20. Accordingly, in this example, when the operator applies pedaling forces to the pedal and crank assembly 13, the pedal sprocket set 18 causes the chain 20 to act on and rotate the front wheel sprocket set and the front wheel 11 thereby propelling the bicycle 10 forward. Further note that while the systems and components described hereinbelow refer to the rear wheel 12 and/or rear wheel sprocket set 19, in other examples these systems and components can be applied to the front wheel 11 and/or the front wheel sprocket set.

The bicycle 10 has a seat 22 on which the operator sits when riding the bicycle 10 and a handlebar 23 that the operator grasps a handlebar 23. An operator input device 24 for receiving inputs from the operator and/or displaying data to the operator is coupled to the handlebar 23. The operator input device 24 can be any suitable device such as a touch screen device and/or cellular telephone. The operator input device 24 can be permanently or removably coupled to any portion of the bicycle 10. Note that the operator input device 24 can be wired to components of the bicycle 10 or the operator input device 24 may wirelessly connect to components of the bicycle 10.

A braking system 113 is coupled to a brake lever 25 on the handlebar 23 such that when the operator engages the lever 25, the braking system 113 slows or stops rotation of the front wheel 11 and/or the rear wheel 12. In one example, pivoting the brake lever 25 actuates the braking system 113. In certain examples, a towed vehicle (not shown) can be coupled to the bicycle 10.

The bicycle 10 also includes an electric motor 30 coupled to the rear of the bicycle 10 near the rear wheel 12 that rotates and/or assists the rotation of the rear wheel 12. In one example, the power or torque delivered by the electric motor 30 via the rear axle to the rear wheel 12 supplements power or torque generated by the operator when manually pedaling the bicycle 10. In other examples, the electric motor 30 rotates the rear wheel 12 when the operator is not pedaling the bicycle 10. Note that in other examples the electric motor 30 can be coupled to the mid-portion or the front portion of the bicycle 10 such that the electric motor 30 rotates and/or assists rotation of the pedal sprocket set 18 or the front wheel 11.

The present inventors have recognized that there is a need in the industry to develop technologies and systems that account for operational factors that affect the electrical power efficiency of the bicycle 10 and the comfort of the operator riding the bicycle 10. Accordingly, the present inventors have developed the apparatuses, systems, and methods described herein that advantageously increase power efficiently of the bicycle 10, prolong battery life, provide additional feedback to the operator, permit further customization of the ride for the operator, sense and monitor interaction of the operator with the bicycle, provide feedback and/or outputs based on use of the bicycle by the operator, and/or provide operator wellness metrics. Note that the term “operational factors” is used herein to refer to factors that affect and/or impact the operation of the bicycle 10 and/or the operator of the bicycle 10. Example operational factors include weight of the operator, weight of any towed vehicle, height of the operator, pedal cadence, hills with inclines and declines, and/or environmental conditions (e.g., wind, heat, precipitation).

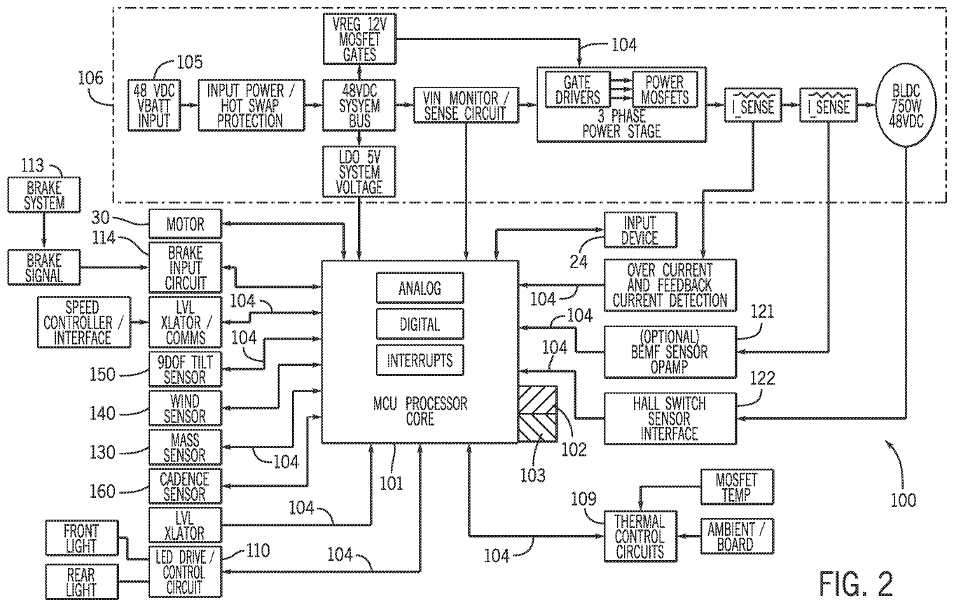

Referring now to FIG. 2, a control system 100 of the present disclosure is depicted in relation to the components of the bicycle 10 described above. Generally, the control system 100 controls operation of the electric motor 30 such that the operator enjoys using the bicycle 10 and/or the power efficiency of the bicycle 10 during use increases compared to conventional control systems and/or bicycles. For example, the control system 100 of the present disclosure may increase the power output from the electric motor 30 in response to high headwinds to thereby reduce the manual effort (e.g., pedaling the bicycle 10) the operator applies to propel the bicycle 10 forward. Note that the labels and verbiage noted on FIG. 2 is exemplary and may be substituted with descriptions provided herein.

The system 100 includes a controller 101 in communication with the electric motor 30 and one or more sensors mounted to the bicycle 10. The sensors, as will be described in greater detail hereinbelow, are configured to sense operational factors related to the environment in which the bicycle 10 is operated, characteristics of the operator of the bicycle 10 and/or other factors (e.g., is a towed vehicle coupled to the bicycle 10). The manner in which the controller 101 controls the electric motor 30 can vary, and in one non-limiting example, the controller 101 controls the electric motor 30 by pulse-width modulation (PWM) to thereby control output current of the electric motor 30 and corresponding power output to one or more axles and/or one or more wheels. Example operational factors include, but are not limited to, weight of the user on the bicycle, weight of the trailer being towed, tailwind and/or headwind acting on the bicycle, temperature of the ambient air, air pressure within the wheels, altitude of the bicycle, and/or tilt of the bicycle on a sloped surface. A person of ordinary skill in the art will recognize that one or more sensors can be utilized to sense one or more operational factors. Each sensor sends inputs, such as information, signals, and/or data, to a controller 101 via wired or wireless communication links 104. Note that the term “input” in used to describe the information, signals, and/or data sent to the controller 101 by the sensors described herein below. The controller 101 is further configured to send outputs such as information, signals, and/or data to connected components and subsystems. The term “output” is used hereinbelow with reference to the controller 100 to describe the information, signals, and/or data sent by the controller 101 to components of the vehicle (e.g., the motor). The illustrated communication links 104 between the exemplary components are merely exemplary, which may be direct or indirect, and may follow alternate pathways. The controller 101 is capable of receiving information and/or controlling one or more operational characteristics of the electric motor 30 and/or other component of the bicycle 10 by sending outputs and receiving inputs via the communication links 104. In one example, the communication link 104 is a controller area network (CAN) bus; however, other types of links could be used. Note that the connections and the communication links 104 may in fact be one or more shared connections, or links, among some or all of the components of the bicycle 10. Based on the inputs received from the sensors, the controller 101 controls operation of the electric motor 30 to propel the bicycle 10. Note that in certain examples, the controller 101 further customizes operation of the bicycle 10 based on the preferences of the operator. Further description of the system 100 (and the components thereof) is provided hereinbelow.

The controller 101 has a processing system 102 and a memory system 103, and the controller 101 can be any suitable device. The memory system 103 may comprise any storage media readable by the processing system 102 and capable of storing executable programs and/or data thereon. The memory system 103 can be implemented as a single storage device, or be distributed across multiple storage devices or sub-systems that cooperate to store computer readable instructions, data structures, program modules, or other data. The memory system 103 may include volatile and/or non-volatile systems, and may include removable and/or non-removable media implemented in any method or technology for storage of information. The storage media may include non-transitory and/or transitory storage media, including random access memory, read only memory, magnetic discs, optical discs, flash memory, virtual memory, and non-virtual memory, magnetic storage devices, or any other medium which can be used to store information and be accessed by an instruction execution system, for example. An input/output (I/O) system (not shown) can provide communication between the controller 101 and the sensors and/or operator input device 24. The processing system 102 loads and executes an executable program or data from the memory system 103, accesses data stored within the memory system 103, and/or controls operation of the electric motor 30 as described in further detail below. In one example, the controller 101 is a microcontroller unit (MCU). The controller 101 is configured to receive inputs from the sensors and/or other components that are in communication with the controller 101. The controller 101 can further receive inputs from a wireless network (e.g., wi-fi network, cellular data network). The controller 101 can be configured to send outputs in the form of analog signals or digital signals to the other components of the system 100. The control system 100 includes one or more subsystems and/or one or more components further described hereinbelow.

The controller 101 and/or the electric motor 30 receive electrical power from an energy storage device 105, such as a 48-volt rechargeable battery or other energy storage and/or supply systems. As such, the energy storage device 105 powers the controller 101 and/or the other components of the system 100. In certain examples, the bicycle 10 includes more than one energy storage devices 105. In still other examples, the bicycle 10 includes a power generator (e.g., alternator) that generates electrical power to thereby recharge the energy storage device 105 and/or power components of the bicycle 10.

The energy storage device 105 is part of or connected to a power distribution system 106 that routes electrical power to the controller 101 and/or other components of the system 100. The power distribution system 106 can be any suitable known power distribution system and may include input power protection circuits with hot swap and reverse voltage protection, 12V DC/DC regulators for powering the motor gate electronics, 3.3/5V DC/DC regulator for components like microcontroller units, sensors, brake signals, and/or operator input device, and/or sensing and protection circuits for over- or under-voltage and overcurrent protection.

The system 100 includes a back electromotive force sensor 121 configured to allow control of the bicycle 10 via an algorithm stored on the controller 101, and a hall effect switch sensor 122 configured to allow control over a hall effect sensor algorithm stored on the controller 101. A thermal control circuit 109 monitors temperatures of components of the system 100 and provides temperature inputs to the controller 101. A light-emitting diode (LED) drive control circuit 110 controls, via the controller 101, front and rear lights to thereby automatically turn the front and/or rear lights on or off in response to sensed lighting conditions (e.g., the lights are turned on when in a tunnel, the lights are turned on at dusk, the lights are turned off at dawn).

The braking system 113 and/or the lever 25 (noted above, see also FIG. 1) is in communication with the controller 101 and therefore can provide braking inputs to the controller 101 via a brake input circuit 114.

The bicycle 10 includes a mass or weight sensor 130 that senses the mass or weight of the operator on the bicycle 10. The mass sensor 130 can be any suitable sensor, such as a strain gauge, an amplifier, or a load cell. In one non-limiting example, the mass sensor 130 is manufactured by TE Connectivity (part/model #FX1901-0001-0100-L).

The mass sensor 130 can be useful, for example, in providing inputs to the controller 101 such that the controller 101 changes operation of the electric motor 30 based on the mass of the operator. For example, if the mass sensor 130 senses a “lighter” operator, the controller 101 decreases the output of the electric motor 30 based on the inputs from the mass sensor 130 that corresponds to the weight of the operator. Accordingly, the controller 101 reduces power consumption by the motor 30 and thereby increases motor efficiency and power efficiency.

In another example, the mass sensor 130 senses the weight of the operator and sends the sensed weight of the operator to the controller 101. Note that the controller 101 could also determine the mass of the operator based on one or more inputs from other sensors and the power output of the motor 30. The controller 101 compares the measured mass sensor input to at least one of a minimum mass threshold, a maximum mass threshold, and a mass range. The mass thresholds and the range may be programmable by the operator via the operator input device 24 (FIG. 1) or predetermined values stored on the memory system 103 of the controller 101. Based on the comparison, the controller 101 increases or decreases power output from the electric motor 30. For instance, if the measured mass sensor input corresponds to a measured mass (e.g., 100.0 kilograms) that is greater than a threshold mass (e.g., 50 kg), the controller 101 increases the power output of the electric motor 30. In another instance, if the measured mass (e.g., 30.0 kg) is less than the threshold mass, the controller 101 decreases the power output of the electric motor 30. In still another instance, if the controller 101 determines that that measured mass is within the mass range, the controller 101, may control the electric motor 30 to predetermined power output that corresponds with the mass range. However, if the measured mass is outside the mass range, the controller 101 may process other inputs when controlling the electric motor 30. Additionally or alternatively, the mass sensor 130 can be configured to only communicate an input to the controller 101 when the sensed mass is within a predetermined mass range.

The bicycle 10 includes a wind sensor 140 that senses wind speed of the air near the bicycle 10 and/or the operator. In one example, the wind sensor 140 is coupled to the handlebar 23 and is orientated to sense headwinds that blow in a direction from the front to the rear of the bicycle 10 (see arrow H on FIG. 1). The wind sensor 140 can be any suitable sensor, such as a thermal anemometer, a differential pressure sensor or a time-of-flight ultrasonic sensor. In one non-limiting example, the wind sensor 140 is manufactured by NXP/Freescale Semiconductor (part/model #MP3V5004DP).

Note that in certain examples, the wind sensor 140 senses both headwinds (as noted above) and tailwinds that blow in a direction from the rear to the front of the bicycle 10 (see arrow T on FIG. 1). In other examples, more than one wind sensors 140 are provided. In one instance, a first wind sensor 140 on the handlebar 23 that senses headwinds and a second wind sensor (not shown) near the rear wheel 12 that senses tailwinds.

The wind sensor(s) 140 can be useful, for example, in generating wind sensor input(s) that are received by the controller 101 such that the controller 101 changes operation of the electric motor 30 based on the winds acting on the bicycle 10 and/or operator. For instance, if the wind sensor 140 senses a headwind, the controller 101 increases output of the electric motor 30 to reduce the manual effort that must be exerted by the operator to propel the bicycle 10 forward. In another instance, if the wind sensor 140 senses a tailwind, the controller 101 decreases the output of the electric motor 30 to reduce power consumption by the motor 30 and thereby increase motor efficiency and energy storage device efficiency.

In another example, the wind sensor 140 senses the headwind and/or the tailwind and communicates a wind sensor input (e.g., headwind speed input and/or tailwind speed input in miles per hour) to the controller 101. Note that the term “wind speed” is used hereinbelow to refer to headwind speed or tailwind speed. The controller 101 compares the measured wind speed to at least one of a minimum wind speed threshold, a maximum wind speed threshold, and a wind speed range. The wind speed thresholds and the range may be programmable by the operator via the operator input device 24 (FIG. 1) or predetermined values stored on the memory system 103 of the controller 101. Based on the comparison, the controller 101 increases or decreases power output from the electric motor 30. For instance, if the measured wind speed (e.g., 20.0 miles per hour) is less than threshold wind speed (e.g., 30.0 mph), the controller 101 keeps the power output of the electric motor 30 constant. In another instance, if the measured wind speed (e.g., 40.0 mph) is more than the threshold wind speed, the controller 101 increases the power output of the electric motor 30 to account for the wind speed and reduce the effort exerted by the operator to pedal through the wind. In still another instance, if the controller 101 determines that that measured wind speed is within the wind speed range, the controller 101, may control the electric motor 30 to predetermined power output that corresponds with the wind speed. However, if the measured wind speed is outside the wind speed range, the controller 101 may process other inputs to control the electric motor 30. Additionally or alternatively, the wind sensor 140 can be configured to only communicate inputs to the controller 101 when the sensed wind speed is within a predetermined wind speed range.

The bicycle 10 includes a tilt sensor 150 that senses tilt of the bicycle 10 relative to one or more planes (e.g., a horizontal plane). Accordingly, the tilt sensor 150 indirectly senses the incline or slope of the road surface along which the bicycle 10 moves. The tilt sensor 150 can be any suitable sensor, such as an accelerometer and an absolute orientation sensor. In one non-limiting example, the tilt sensor 150 is manufactured by Bosch Sensortec (part/model #BN0055).

The tilt sensor 150 can be useful, for example, in providing inputs to the controller 101 such that the controller 101 changes operation of the electric motor 30 based on the tilt of the bicycle 10. For instance, if the tilt sensor 150 senses the bicycle 10 is tilted in a direction from the front to the rear (see arrow H on FIG. 1) (e.g., the bicycle 10 is on an incline), the controller 101 increases output of the electric motor 30 to reduce the effort from the operator must exert to pedal up the incline. In another instance, if the tilt sensor 150 senses the bicycle 10 is tilted in a direction from the rear to the front (see arrow T) (e.g., the bicycle 10 is on a decline), the controller 101 decreases the power output of the motor 30 to reduce power consumption by the motor 30 and thereby increase motor efficiency and energy storage device efficiency.

In another example, the tilt sensor 150 senses the tilt of the bicycle 10 and communicates tilt inputs to the controller 101. The controller 101 compares the measured tilt to at least one of a minimum tilt threshold, a maximum tilt threshold, and a tilt range. The tilt thresholds and the range may be programmable by the operator via the operator input device 24 (FIG. 1) or predetermined values stored on the memory system 103 of the controller 101. Based on the comparison, the controller 101 increases or decreases power output from the motor 30. For instance, if the measured tilt is (e.g., measured tilt corresponds to a +5.0% grade of the road surface) is less than the tilt threshold (e.g., +10.0% grade), the controller 101 keeps the power output of the electric motor 30 constant. In another instance, if the measured tilt (e.g., +5.0% grade) is greater than the tilt threshold, the controller 101 increases the power output of the electric motor 30 to account for the grade of the roadway and reduce the effort exerted by the operator to pedal up the incline/hill. In still another instance, if the controller 101 determines that that measured tilt is within the tilt range, the controller 101, may control the electric motor 30 to predetermined power output that corresponds with the tilt. However, if the measured tilt is outside the tilt range, the controller 101 may process other inputs to control the electric motor 30. Additionally or alternatively, the tilt sensor 150 can be configured to only communicate inputs to the controller 101 when the sensed tilt is within a predetermined tilt range.

In another example, a cadence sensor 160 senses the rate at which the operator is pedaling the bicycle 10 and the controller 101 receives inputs from the cadence sensor 160. In one example, the cadence sensor 160 has a magnet on the pedal and crank assembly 13 that is configured to turn the electric motor 30 “ON” when the operator starts pedaling and turn the electric motor 30 “OFF” when the operator stops pedaling. In one example, if the sensed cadence (e.g., revolutions per second) is lower than a predetermined cadence stored on the memory system 103, the level or magnitude of power or pedal assist from the electric motor 30 is adjusted until the sensed cadence equals the predetermined cadence (e.g., the electric motor is activated to thereby apply power such that the cadence of the operator increases). In another example, variable rates of power or pedal assist from the electric motor 30 are added based on the sensed cadence to thereby bring the actual cadence to a predetermined cadence at a desired pedal assist level.

In another example, the cadence sensor 160 senses the cadence and the controller 101 compares the measured cadence sensor input (that corresponds to an actual cadence of the pedals) to a predetermined cadence. The predetermined cadence can be a threshold cadence or a cadence range programmable by the operator via the operator input device 24 (FIG. 1) or predetermined values stored on the memory system 103 of the controller 101. Based on the comparison, the controller 101 increases or decreases power output from the motor 30.

In another example, a towing weight sensor (not shown) can be implemented to determine the weight of a vehicle coupled to and towed by the bicycle 10. The towing weight sensor communicates weight of the towed vehicle to the controller 101, and the accordingly, the controller 101 can control power output from the motor 30 based on the weight of the towed vehicle. Thus, the controller 101 can efficiently operate the motor 30 and avoid damaging the motor 30 when the bicycle 10 is towing the towed vehicle.

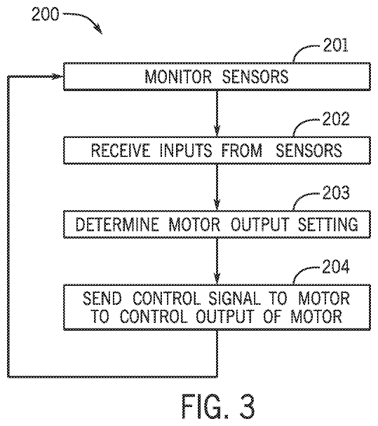

Referring now to FIG. 3, an example method 200 for controlling the bicycle 10 and the motor 30 is depicted as a flow diagram. In some examples, the controller 101 monitors one or more sensors 130, 140, 150, 160 (described above) at step 201 such that the controller 101 receives inputs from the sensors 130, 140, 150, 160 at step 202. Note that the sensors 130, 140, 150, 160 may be configured to continuously or periodically send inputs to the controller 101 (e.g., a continuous feedback loop). The sensors 130, 140, 150, 160 could also be configured to send inputs only after the sensors 130, 140, 150, 160 reach a threshold value (e.g., the wind sensor 140 sends inputs only after the wind sensor 140 senses winds above 10.0 mph). The controller 101 at step 203 processes the input(s) and determines power output of the motor based on the input(s) from the sensors 130, 140, 150, 160. The controller 101 sends an output to the motor 30 to thereby control operation of the motor 30 to the determined power output of the motor at step 204. The method returns to step 201 to thereby continuously monitor operational factors impacting operation of the bicycle 10 so that the controller 101 can continuously adjust operation of the motor 30.

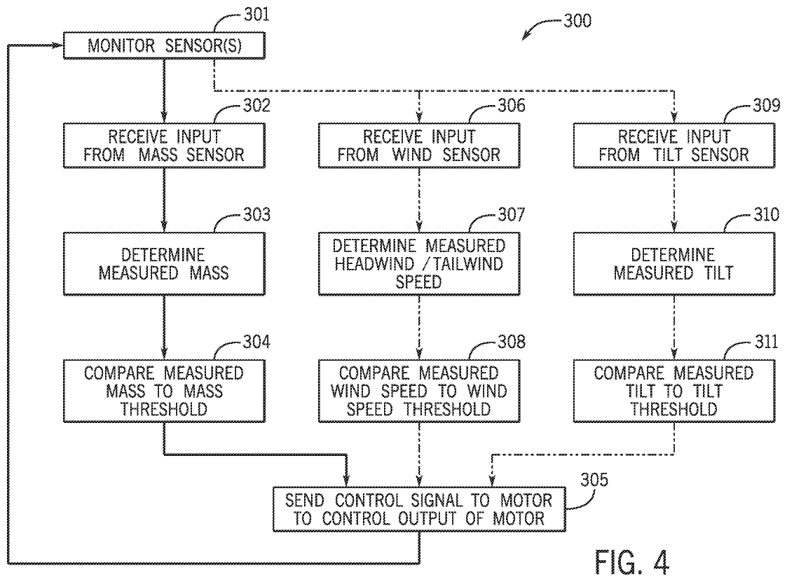

FIG. 4 depicts another example method 300 for controlling the bicycle 10 and the motor 30. According to this example method, the controller 101 monitors one or more sensors 130, 140, 150, 160 (described above) at step 301. At step 302 the controller 101 receives a mass input from the mass sensor 130 that corresponds to the weight of the operator using the bicycle 10. The controller 101 processes the measured mass sensor input to determine the measured mass of the operator at step 303 and compares the measured mass to a predetermined mass threshold stored on the memory system 103 at step 304. Note that the mass threshold may correspond to values of a look-up table. Based on the comparison of the measured mass to the mass threshold, the controller 101 sends an output to the motor 30 such that the motor 30 outputs a predetermined power output of the motor at step 305. Thus, the power output of the motor 30 corresponds to the measured mass of the operator such that operation of the bicycle 10 and/or the motor 30 is adjusted based on the weight of the operator. The method returns to step 301 to thereby continuously monitor mass of the operator on the bicycle 10 and thereby continuously adjust operation of the motor 30.

In certain examples, the controller 101 determines the power output necessary to accelerate to a predetermined speed (e.g., miles per hour), or maintain the speed of the bicycle 10 at a predetermined speed, based on one or more sensors. For instance, inputs from the wind sensor 140 and the tilt sensor 150 may be utilized by the controller 101 to thereby determine that the power output from the motor 30 must be 1.0 kWh to maintain a predetermined speed. The controller 101 could also determine, based on the power output need to maintain the predetermined speed and/or the inputs from the sensors, the weight of the operator.

Note that while the method described with reference to FIG. 4 is based on the mass of the operator and the mass sensor 130, the other sensors, such as the wind sensor 140 and the tilt sensor 150 can be alternatively or additionally incorporated in the method described above with respect to FIG. 4. For instance, the method may further include step 306 such that the controller 101 receives a measured wind sensor input from the wind sensor 140 that corresponds to the wind speed (e.g., tailwind speed or headwind speed) acting on the bicycle 10. Note that in certain examples the measured wind sensor input can a wind speed value that corresponds to a sensed wind speed (e.g., 12.0 miles per hour). The controller 101 processes the measured wind sensor input to determine the measured wind speed at step 307 and compares the measured wind speed to a predetermined wind speed threshold stored on the memory system 103 at step 308. Note that the wind speed threshold may be part of a look-up table. Based on the comparison of the measured wind speed to the wind speed threshold and the measured mass to the mass threshold, the controller 101 sends an output to the motor 30 to thereby control operation of the motor 30 such that the motor 30 outputs the predetermined power output of the motor at step 305. Thus, the power output of the motor 30 and operation of the bicycle 10 is adjusted based on both the weight of the user and the measured wind speed acting on the bicycle 10.

Furthermore, the method may include step 309 such that the controller 101 receives tilt input from the tilt sensor 150 that corresponds to the tilt of the bicycle 10. The controller 101 processes the tilt input to determine the measured tilt at step 310 and compares the measured tilt to a predetermined tilt threshold stored on the memory system 103 at step 311. Note that the tilt threshold may be part of a look-up table. Based on the comparison of the measured tilt to the tilt threshold, the measured wind speed to the wind speed threshold, and/or the measured mass to the mass threshold, the controller 101 sends an output to the motor 30 to thereby control operation of the motor 30 such that the motor 30 outputs the predetermined power output of the motor at step 305. Thus, the power output of the motor and operation of the bicycle 10 is adjusted based on both the weight of the user, the wind acting on the bicycle 10, and the tilt of the bicycle 10.

The above-described methods can further include the steps of the controller 101 receiving an input from the operator via the operator input device 24 (FIG. 1) such that the output from the controller 101 further modifies operation that will affect operation of the motor 30 (FIG. 1). Note that the user inputs may be processed by the controller 101 at the same time as the sensor inputs such that the user inputs and the sensor inputs are collectively processed by the controller 101 before sending further outputs. For example, the user may select or input a desired “Motor Assist” level and/or a desired workout profile that affects the operation of the motor 30. For instance, the operator selects a Level 3 Motor Assist, the controller 101 controls the motor such that motor operates at no more than 60.0% of the maximum power output. In another instance, the operator selects an “interval-training” program, and the controller 101 would control by motor (and the sensor inputs) based on the program. In this instance, the controller 101 can receive feedback inputs from the cadence sensor and/or compute calories burned by the operator to thereby automatically adjust operation of the motor 30 to achieve the parameters of the selected program.

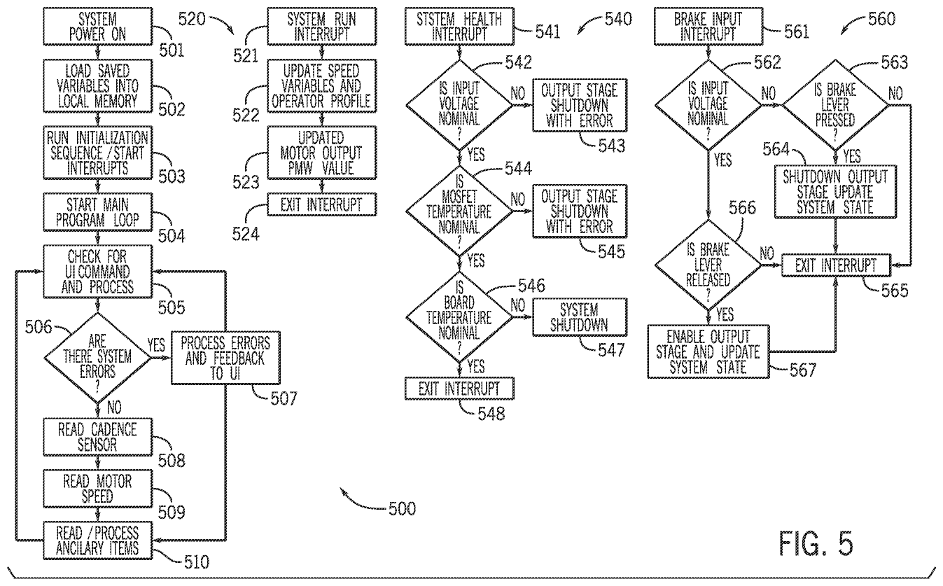

Referring now to FIG. 5, an example operational sequence or method 500 for operating the bicycle 10 is depicted. The steps are described hereinbelow and a person of ordinary skill in the art will recognize that in other examples, certain steps may be combined or excluded. Furthermore, a person of ordinary skill in the art will recognize that the steps and/or components described herein with reference to any of the Figures and methods described herein above and below may be incorporated into any of the other methods depicted and described. Note that the methods described herein above and below may be incorporated into programs stored on the memory system 103.

The method 500 include initiating or turning the power to the components of the bicycle 10, such as the controller 101 (FIG. 2), at step 501. The electric power is received from the energy storage device 105 (FIG. 2, described above). The controller 101 loads saved settings and/or variables (described further hereinbelow) that are stored on the memory system 103, at step 502. These setting and/or variables can be predetermined such that each time the bicycle 10 is powered on the same settings and/or variables are loaded. In other examples, the settings and/or variables could be determined when the power to the bicycle 10 was turned off. At step 503 a predetermined initialization sequence and/or one or more system interrupts (described further herein below) are started by the controller 101. Thereafter, the controller 101 starts a main program loop at step 504 that includes checking for inputs from the operator input device 24 (FIG. 2) and checks the bicycle 10 and/or components thereof for errors at step 506. If errors are detected, the controller 101 processes the errors and provides output in the form of feedback to the operator via the operator input device 24 at step 507. The feedback to the operator may include visual cues (e.g., error images displayed on the operator input device 24) and/or auditable alerts to direct the operator to correct the error. The method can then return to checking for inputs from the operator input device 24 at step 505 and/or processing inputs from ancillary components at step 510 (described further herein).

If no errors are detected, the controller 101 processes inputs from the sensors, such as the cadence sensor 160 (FIG. 2), and feedback from the motor 30 (FIG. 2) at steps 508 and 509. The controller 101 further processes inputs from ancillary components. The controller 101 thereby controls the operation of the motor 30 and/or other components of the bicycle 10 and continuously checks for commands from the operator input device 24 at step 505.

As noted above, at step 503 one or more system interrupts 520, 540, 560 be initiated and/or processed by the controller 101. The system interrupts 520, 540, 560 may be initiated based on a predetermined schedule and sequence stored on the memory system 103.

In one example, a first system interrupt 520 is initiated at step 521 and is for updating bicycle speed variables and/or a profile of the operator at step 522. The profile of the operator can be stored on the memory system 103 and include variables such as weight of the operator, age of the operator, and/or skill level of the operator. Based on the speed variables and/or a profile of the operator, the controller 101 updates the power output of the motor 30 at step 523. The controller 101 may update the power output of the motor 30 by changing pulse width modulation (PWM) values. The first system interrupt 520 thereafter terminates at step 524.

In another example, a second system interrupt 540 is initiated at step 541 and is for checking the “health” of the bicycle 10 and/or the components thereof (e.g., the controller 101). For example, the controller 101 may check battery life (e.g., undervoltage or overvoltage), circuit temperature, stalled or locked rotor, overcurrent on the drive stage, broken or missing connection with sensors, and/or motor fault. At step 542, the controller 101 determines if the input voltage from the energy storage device 105 is nominal, below, or above a minimum threshold. If the input voltage is not nominal, the controller 101 outputs signals for a first stage shutdown with corresponding error code to the operator via the operator input device 24 at step 543. Accordingly, the systems are safe to remain powered however, power to the motor 30 is shut off by the controller 101. If the input voltage is nominal, the controller 101 processes inputs from a first temperature sensor (not shown) that senses temperature of a first component of the controller 101 such as a MOSFET at step 544. If the controller 101 determines that the sensed temperature of the first component is not nominal or less than or greater than a first threshold temperature, the controller 101 outputs signals for a second stage shutdown with corresponding error code to the operator via the operator input device 24 at step 545. Accordingly, to protect the system from further damage power does not flow to the controller 101. If the sensed temperature of the first component is nominal, the controller 101 processes inputs from a second temperature sensor (not shown) that senses temperature of a second component of the controller 101 such as the board at step 546. If the controller 101 determines that the sensed temperature of the second component is nominal or less than or greater than a second threshold temperature, the controller 101 outputs signals for a system shutdown (at step 547) and provides feedback to the operator via the operator input device 24 (similar to step 545). Accordingly, to protect the system from further damage power does not flow to the controller 101. The second system interrupt 540 thereafter terminates at step 548.

In another example, a third system interrupt 560 is initiated at step 561 and is for checking status of the braking system 113 (FIG. 2). At step 562, the controller 101 determines if the braking system 113 is in a braking state in which the braking system 113 is braking the wheel(s) 11, 12 of the bicycle 10 to thereby slow the speed of the bicycle 10. If the braking system 113 is not in a braking state, the controller 101 determines if the lever of the braking system 113 is depressed, for example via sensors (not shown), at step 563. If the lever of the braking system 113 is depressed, the controller 101 outputs signals for a system shutdown and updates the state of the system at step 564 and the third system interrupt 560 terminates at step 565. If the lever of the braking system 113 is not depressed, the third system interrupt 560 terminates at step 565. Returning now to step 562 above, if the braking system 113 is in the braking state, the controller 101 determines if the lever of the braking system 113 is released, for example via sensors, at step 566. If the lever of the braking system 113 is released, the controller 101 outputs signals for a system shutdown and updates the state of the system at step 567 and the third system interrupt 560 terminates at step 565. If the lever of the braking system 113 is not released, the third system interrupt 560 terminates at step 565.

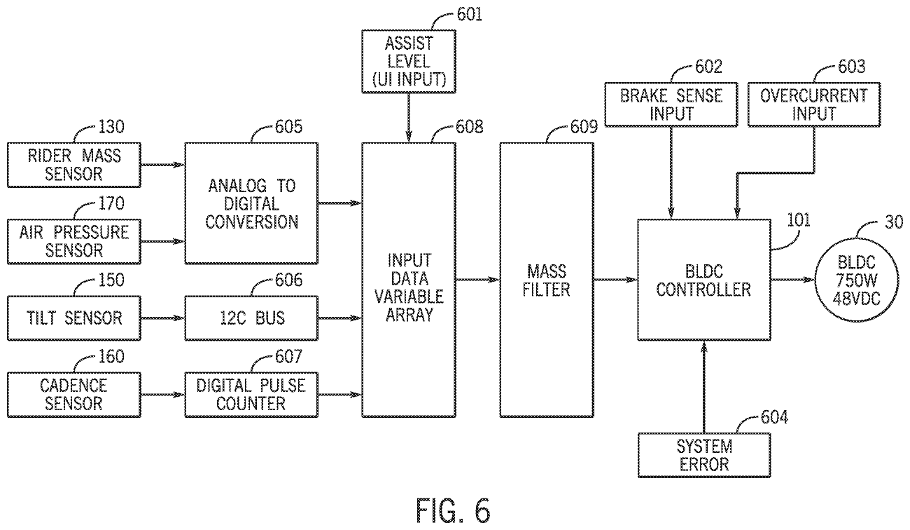

Referring now to FIG. 6, a diagram of an example PWM generation circuit that maybe part of the controller 101. In this example, one or more sensors (e.g., mass/weight sensor 130, air pressure sensor 170, tilt sensor 150, cadence sensor 160) sense different operational factors and generate and send inputs. The controller 101 may also receive inputs pertaining to an operator desired power or pedal assist 601 via the operator input device 24 (FIG. 2), a brake sense input 602 from a sensor that senses operation of the braking system 113, an overcurrent input 603 from a sensor that senses overcurrent, and/or system errors 604 from various components of the bicycle 10. Note that the inputs can be received, processed, and/or altered before being received into the controller 101 via various components, systems, processes, and/or methods. For example, inputs from mass sensor 130 and the air pressure sensor 170 are processed by an analog to digital converter 605. In another example, inputs from the tilt sensor 150 are communicated along an I²C bus and inputs from the cadence sensor 160 are processed by the digital phase counter 607.

The inputs (either processed as noted above or “unprocessed”) are processed and/or received into an input data variable array 608, and a mass filter 609 applies predetermined coefficients to one or more inputs. The controller 101 uses the processed inputs to adjust and/or update the power output of the motor 30 by changing pulse width modulation (PWM) values.

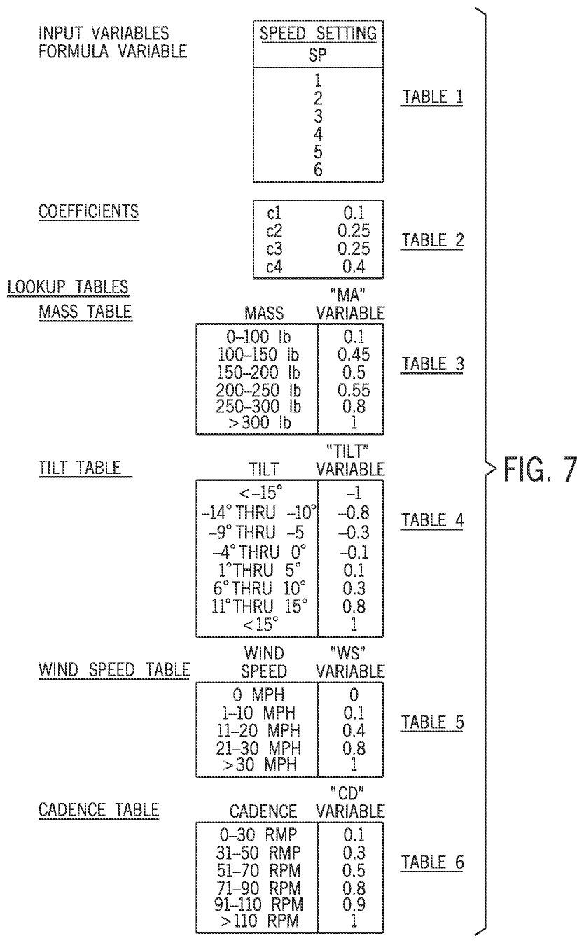

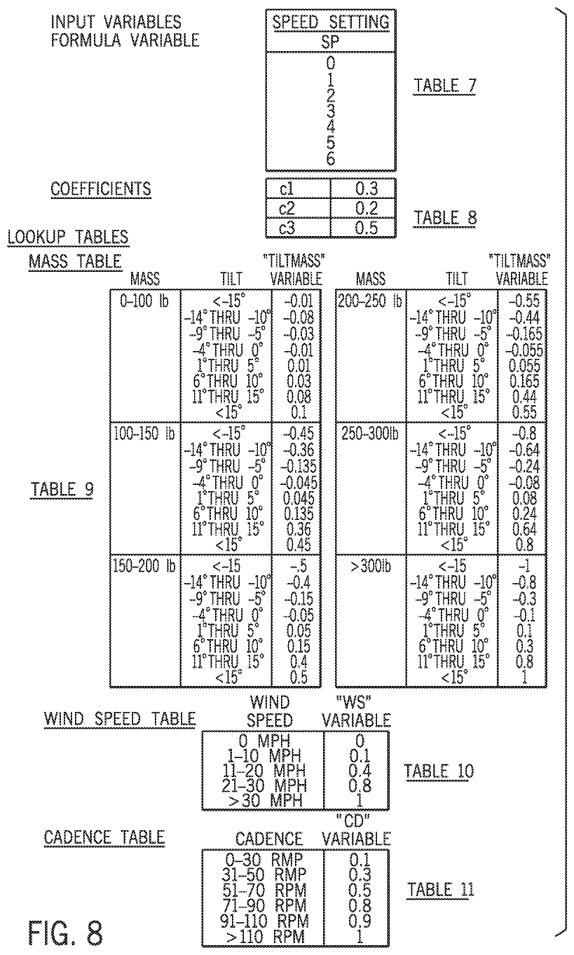

Referring now to FIGS. 7-8, the controller 101 may utilize one or more formulas and one or more lookup tables to determine the power output of the motor 30 based on inputs (and/or values thereof) from components of the bicycle 10, such as the various sensors noted above. FIG. 7 depicts example tables that correspond to a first example formula (Formula 1) described hereinbelow, and FIG. 8 depicts example tables that correspond to a second example formula (Formula 2). Note that the formulas and the tables can be stored on the memory system 103 of the controller 101.

In one example, the PWM output from the controller 101 to thereby control power output of the motor 30 is determined by the following Formula 1.

PWM output=(sp/6)*100*(C1*ma+C2*tilt+C3*ws+C4*cd) Formula 1

a. Description of Values and Variables:
i. PWM output=an integer in the range of 0 to 100, and the PWM output integer corresponds to a power output of the motor 30. For example, a PWM output of 46 corresponds to a duty cycle of 46.0%
ii. sp=speed setting input inputted by the operator via the operator input device 24. Table 1 of FIG. 7 depicts example speed setting values that can be selected by the operator. The speed setting input corresponds to a desired speed of the vehicle (e.g., 7.0 miles per hour) or a desired speed range of the vehicle (e.g., 5.0-10.0 miles per hour).
iii. C1-C4=operating coefficient values. Table 2 of FIG. 7 depicts example coefficient values.
iv. ma=mass or weight of the user as inputted by the user via the operator input device 24 or sensed by the mass sensor 130. Table 3 depicts example mass ranges and variables.
v. tilt=tilt of the bicycle 10 sensed by the tilt sensor 150. Table 4 depicts example tilt ranges and variables.
vi. ws=wind speed affecting the operation of the bicycle 10 as sensed by the wind sensor 140. Table 5 depicts example wind speed ranges and variables.
vii. cd=cadence of the pedaling operator as sensed by the cadence sensor 160. Table 6 depicts example cadence ranges and variables.

The one or more inputs received by the controller 101 will correspond to one or more variables or values noted above. The controller 101 processes the inputs using one or more Tables (see FIG. 7) such that the values used in Formula 1 can be determined. Accordingly, computation of Formula 1 with the value of the variables permits the controller 101 to determine PWM output (e.g., PWM value, PWM signal) and the control operation of the motor 30.

In one example, the operator selects speed setting “5” via the operator input device 24. Note that in Table 1 “0” may correspond to a slow speed (e.g., 5.0 miles per hour) and “6” may correspond to a fast speed (e.g., 20.0 mph). The mass sensor 130 senses the weight of the operator to be 175 pounds (lbs), and accordingly, the controller 101 uses 0.50 in Table 3 for the mass variable (ma). Note that the mass ranges noted in Table 3 can vary. The tilt sensor 150 senses the tilt to be +8.0 degrees, and accordingly, the controller 101 uses 0.30 in Table 4 for the tilt variable (tilt). Note that the tilt ranges in Table 4 can vary. The wind sensor 140 senses the wind speed to be 9.0 MPH, and accordingly, the controller 101 uses 0.10 in Table 5 for the wind speed variable (ws). Note that the wind speed ranges in Table 5 can vary. The cadence sensor 160 senses the cadence to be 55.0 revolutions per minute (RPM), and accordingly, the controller 101, uses 0.50 in Table 6 for the cadence variable (cd). Thus, PWM output=(6/6)*100*(0.1*0.50+0.25*0.30+0.25*0.10+0.40*0.50)=35. Accordingly, the controller 101 controls the motor 30 to 35.0% of the maximum power output.

In another example, the PWM output from the controller 101 to thereby control power output of the motor 30 is determined by the following Formula 2.

PWM output=(sp/6)*100*(C1*ma+C2*tilt+C3*ws+C4*cd) Formula 2

In this example, the controller 101 utilizes Tables 7-11 depicted on FIG. 8 and inputs from various sensors similar to the description above with respect to Formula 1. Note that in this example, Table 9 includes values based on inputs from the mass sensor 130 and the tilt sensor 150. Accordingly, the controller 101 determines value of the tilt mass variable based on inputs from the mass sensor 130 and the tilt sensor 150 and uses the value in Formula 2.

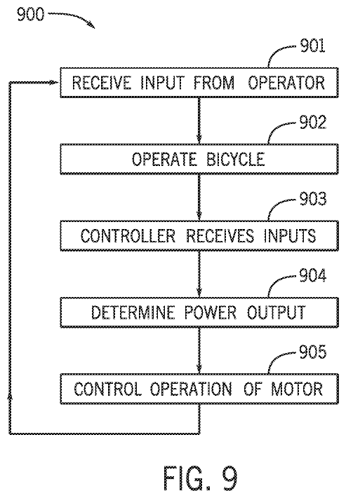

Referring now to FIG. 9, another example method 900 for operating the bicycle 10 is depicted. The method 900 is for operating the bicycle 10 (FIG. 1) based at least in part on the number of calories the operator wishes to burn while riding the bicycle 10. Generally, as will be described in greater detail herein below, the operator inputs the number of calories they wish to expend (referred to hereafter “desired calorie expenditure”) into the controller 101 via the operator input device 24. Based on the desired calorie expenditure and inputs from one or more sensors (described above) that sense one or more operational factors, the controller 101 sends output(s) to the motor 30 to thereby operate the motor 30 such that the operator achieves the desired calorie expenditure by the conclusion of their ride. The motor 30 outputs a predetermined power output of the motor 30 to either (1) assist the operator in propelling the bicycle 10 and thereby decrease the number of calories the operator expends to propel the bicycle 10 or (2) create resistance that requires the operator to exert more effort to propel the bicycle 10 and thereby increase the number of calories the operator expends to propel the bicycle 10.

The example method 900 for controlling the bicycle 10 starts by receiving an input via the operator input device 24 from the operator at step 901. The input can be a desired calorie expenditure (e.g., 500.0 calories, 1257.0 calories, 5000.0 calories) that is selected from a predetermined list of calories values stored on the memory system 103 or entered by the operator using a keypad with numerals. At step 902, the operator then begins to operate the bicycle by exerting force on the drive system 17, i.e. pedaling, and the controller 101 receives inputs from one or more sensors 130, 140, 150, 160 at step 903. For example, the controller 101 receives inputs from the mass sensor 130 that senses the weight of the operator, the wind sensor 140 senses the wind speed of the tailwind or the headwind, the tilt sensor 150 senses the tilt of the bicycle 10 on an incline or decline, and/or the cadence sensor 160 senses the cadence of the operator pedaling the bicycle 10.

At step 904, the controller 101 processes the inputs in relation to a lookup table stored on the memory system 103 to determine the power output of the motor 30. For example, the lookup table can include numerous columns with values that relate to each of the inputs from the sensors 130, 140, 150, 160 (e.g., a column with wind speed values such as 5.0 mph, 10.0 mph; a column with mass values such as 80.0 kg, 82.0 kg) and a column with a prescribed power output to the motor 30. The controller 101 compares the inputs to the values in the lookup table and determines a row in which the inputs match the values in the row. The determined row has a prescribed power output value to the motor 30, and the controller 101 thereby controls the motor 30 such that the motor 30 outputs the prescribed power output to the motor 30. Note that in certain examples, the controller 101 processes with an algorithm or formula that determines the required power output of the motor 30 such that the operator achieves the desired calorie expenditure.

The controller 101, at step 905, sends an output to the motor 30 to thereby control operation of the motor 30 to the determined power output of the motor 30 at step 904. The method returns to step 901 to thereby continuously receive inputs from the sensors 130, 140, 150, 160 and continuously monitor operational factors impacting operation of the bicycle 10. As such, the controller 101 can continuously adjust operation of the motor 30 such that the operator achieves the desired calorie expenditure for their ride.

In one example, the motor 30 is operated by the controller 101 such that the motor 30 rotates at least one of the wheels 11, 12 forward to thereby assist the operator in propelling the bicycle 10. When this occurs, the operator may maintain or reduce the rate at which they expend calories to propel the bicycle 10. In another example, the motor 30 is operated by the controller 101 such that the motor 30 applies resistance to at least one of the wheels 11, 12 (e.g., the polarity of the motor is reversed such that the motor 30 rotates in a direction opposite the direction in which the motor rotates when assisting forward propulsion of the bicycle). As such, the rate at which the operator expends calories increases as the operator overcomes the resistance added by the motor 30. In one specific example, the motor 30 applies enough resistance while the bicycle 10 is moving down a hill with a steep decline such that the operator must pedal to continue moving down the hill. In this specific example, the operator thereby exerts calories while propelling the bicycle 10 down the hill instead of otherwise “coasting” down the hill.

Note that in certain examples the mass input from the mass sensor 130 can be processed by the controller 101 in relation to the other inputs (e.g., cadence from the cadence sensor 150) to determine the number of calories the operator will exert given their mass and the work (e.g., their cadence) they are exerting to propel the bicycle 10. In these examples, the controller 101 may further determine a calorie expenditure rate (e.g., 10.0 calories per minute) and therefore the controller 101 can forecast the duration of time necessary for the operator to propel the bicycle and thereby achieve their desired calorie expenditure. The controller 101 can further be configured to aggerate the number of calories expended by multiplying the computed calorie expenditure rate times the length of time the operator maintains the calorie expenditure rate. The controller 101 may then determine the number of calories burned by the operator in “real-time”, forecast the time at which the operator may achieve the desired calorie expenditure, and/or adjust operation of the motor 30 to increase or decrease the calorie expenditure rate so that the operator achieves the desired calorie expenditure.

In certain examples, a bicycle is for use by an operator. The bicycle includes a frame having a front wheel and a rear wheel rotatably coupled thereto. A manual drive system with a pedal and crank assembly is configured to be engaged by the operator such that the operator can rotate the rear wheel and propel the bicycle. An electric motor is coupled to the frame and configured to receive electrical energy from an energy storage device and drive at least one of the wheels to thereby assist the operator in propelling the bicycle. A wind sensor is configured to sense winds acting on the bicycle and generate a measured wind sensor input. A control system is operable to control a power output of the electric motor, wherein the control system receives the measured wind sensor input and controls the power output of the electric motor based at least in part on the wind sensor input.

In certain examples, when the measured wind sensor input corresponds to headwinds acting on the bicycle, the control system controls the electric motor to thereby increase the power output of the electric motor and assist the operator in propelling the bicycle. In certain examples, when the measured wind sensor input corresponds to tailwinds acting on the bicycle, the control system controls the electric motor to thereby decrease the power output of the electric motor and thereby increase power efficiency of the bicycle. In certain examples, the control system sends a pulse width modulation (PWM) output to the electric motor based on the measured wind sensor input to thereby control the power output of the motor.

In certain examples, the control system compares the measured wind speed to a threshold wind speed stored on a memory system of the control system such that when the control system determines that the measured wind speed is greater than the threshold wind speed, the control system controls the electric motor to increase the power output and the electric motor assists the operator in propelling the bicycle. When the control system determines that the measured wind speed is less than the threshold wind speed, the control system controls the electric motor to decrease the power output and thereby increase power efficiency of the bicycle. In certain examples, the control system compares the measured wind speed to a lookup table stored on the memory system that has wind speed ranges and corresponding predetermined power outputs. In certain examples, the control system compares the measured wind speed to the lookup table to thereby determine the wind speed range the measured wind speed is within and then controls the electric motor to adjust the power output to the corresponding predetermined power output to thereby assist the operator in propelling the bicycle.

In certain examples, the wind sensor is a first wind sensor that generates a first measured wind sensor input and further includes a second wind sensor configured to sense winds acting on the bicycle and generate a second measured wind sensor input. The first wind sensor is positioned at a front of the bicycle to thereby sense headwinds and the second wind sensor is positioned at an opposite rear of the bicycle to thereby sense tailwinds. The control system receives the first measured wind sensor input and the second measured wind sensor input and further controls the power output of the electric motor based on the first and second measured wind speed sensor inputs.

In certain examples, the first wind sensor input corresponds to a measured headwind speed acting on the bicycle and the second measured wind sensor input corresponds to a measured tailwind speed. The control system is configured to compare the measured headwind speed to the measured tailwind speed the thereby control the power output of the electric motor based on the greater of the measured headwind speed and the measured tailwind speed.

In certain examples, a vehicle is for use by an operator. The vehicle has a frame with a front wheel and a rear wheel rotatably coupled thereto. An electric motor is coupled to the frame and configured to receive electrical energy from an energy storage device and provide a power output to drive one of the front or back wheels to propel the vehicle. A wind sensor is configured to sense winds acting on the vehicle and generate measured wind sensor input. A control system is operable to control a power output of the electric motor, and the control system receives the measured wind sensor input and controls the power output of the electric motor based at least in part on the measured wind sensor input.

In certain examples, when the measured wind sensor input corresponds to headwinds acting on the vehicle, the control system controls the electric motor to thereby increase the power output of the electric motor. In certain examples, when the measured wind sensor input corresponds to tailwinds acting on the vehicle, the control system controls the electric motor to thereby decrease the power output of the electric motor. In certain examples, the control system sends a pulse width modulation (PWM) output to the electric motor based at least in part on the wind sensor input to thereby control the power output of the motor.

In certain examples, the control system compares the measured wind speed to a threshold wind speed stored on a memory system of the control system such that when the control system determines that the measured wind speed is greater than the threshold wind speed, the control system controls the electric motor to increase the power output and assist the operator in propelling the vehicle. In certain examples, when the control system determines that the measured wind speed is less than the threshold wind speed, the control system controls the electric motor to decrease the power output and thereby increase power efficiency of the vehicle.

In certain examples, the wind sensor is a first wind sensor that generated a first measured wind sensor input and further includes a second wind sensor configured to sense winds acting on the vehicle and generate a second measured wind sensor input. The first wind sensor is positioned at a front of the vehicle to thereby sense headwinds and the second wind sensor is positioned at an opposite rear of the vehicle to thereby sense tailwinds. The control system receives the first wind sensor input and the second wind sensor input and controls the power output of the electric motor based upon the first and second wind sensor inputs.

In certain examples, a method for controlling an electric motor on a vehicle designed to be used by an operator can include the steps of providing a control system operable to control a power output of the electric motor of the vehicle and receiving, via an operator input device, a speed setting input at the control system from the operator of the vehicle that corresponds to a desired speed of the vehicle. The example method can further include the steps of sensing mass of the operator and generating a measured mass sensor input that is sent to a control system, sensing wind acting on the vehicle and generating a measured wind sensor input that is sent to the control system, processing, with the control system, the measured mass sensor input and the measured wind sensor input to determine a desired power output of the motor to maintain the vehicle at the desired speed of the vehicle inputted into the operator input device, and operating the motor, with the control system, at the desired power output.

In certain examples, the control system generates a pulse width modulation (PWM) power output signal to control the power output of the electric motor. In certain examples, the control system utilizes an algorithm stored on a memory system to determine the desired power output of the electric motor based on the measured mass sensor input and the measured wind sensor input. In certain examples, the algorithm applies predetermined coefficients to each of the measured mass and measured wind sensor inputs when determining the desired power output of the electric motor. In certain examples, the processing of the measured mass sensor input and the measured wind sensor input includes the control system comparing the measured mass sensor input and the measured wind sensor input to a lookup table stored on a memory system. The lookup table has predetermined mass input ranges and predetermined wind speed ranges that correspond to predetermined power outputs of the motor. The control system can compare the measured mass sensor input and the measured wind sensor input to the lookup table to thereby determine a corresponding predetermined power output of the motor.

In certain examples, the method can include the steps of sensing cadence and generating a measured cadence sensor input that is sent to the control system and processing, with the control system, the measured cadence sensor input with the measured mass sensor input and the measured wind sensor input to determine the desired power output for controlling the electric motor.

In certain examples, a bicycle for use by an operator includes a frame having a front wheel and a rear wheel rotatably coupled thereto. A manual drive system with a pedal and crank assembly that the operator engages to thereby rotate rear wheel and propel the bicycle. An electric motor coupled to the frame and configured to receive electrical energy from an energy storage device and drive at least one of the wheels to thereby assist the operator in propelling the bicycle or resist rotation of at least one of the wheels to thereby increase resistance the operator experiences while pedaling the pedal and crank assembly. A mass sensor is configured to sense a mass of the operator and generate a measured mass sensor input, a cadence sensor is configured to sense a cadence of the pedal and crank assembly and generate a measured cadence sensor input, and an operator input device is configured to receive an operator input from the operator that corresponds to a desired calorie expenditure. A control system that receives the measured mass sensor input, the measured cadence sensor input, and the operator input and determines a power output of the electric motor to match the desired calorie expenditure of the operator.

In certain examples, the control system controls the electric motor over time to vary the power output of the electric motor to thereby assist or resist propulsion of the bicycle such that calories expended by the operator over time is equal to the desired calorie expenditure of the operator.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives, and modifications are possible within the scope of the appended claims.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A bicycle for use by an operator, comprising:
a frame having a front wheel and a rear wheel rotatably coupled thereto;
a manual drive system with a pedal and crank assembly that the operator engages to thereby rotate the rear wheel and propel the bicycle;
an electric motor coupled to the frame and configured to receive electrical energy from an energy storage device and drive at least one of the wheels to thereby assist the operator in propelling the bicycle;
a wind sensor configured to sense winds acting on the bicycle and generate a measured wind sensor input;
a control system operable to control a power output of the electric motor, wherein the control system receives the measured wind sensor input and controls the power output of the electric motor based at least in part on the measured wind sensor input.

2. The bicycle according to claim 1, wherein when the measured wind sensor input corresponds to headwinds acting on the bicycle, the control system controls the electric motor to thereby increase the power output of the electric motor and assist the operator in propelling the bicycle; and
wherein when the measured wind sensor input corresponds to tailwinds acting on the bicycle, the control system controls the electric motor to thereby decrease the power output of the electric motor and thereby increase power efficiency of the bicycle.

3. The bicycle according to claim 1, wherein the control system sends a pulse width modulation (PWM) output to the electric motor based on the measured wind sensor input to thereby control the power output of the motor.

4. The bicycle according to claim 1, wherein the control system compares the measured wind sensor input to a threshold wind speed stored on a memory system of the control system such that:
when the control system determines that the measured wind speed is greater than the threshold wind speed, the control system controls the electric motor to increase the power output and the electric motor assists the operator in propelling the bicycle; and
when the control system determines that the measured wind speed is less than the threshold wind speed, the control system controls the electric motor to decrease the power output and thereby increase power efficiency of the bicycle.

5. The bicycle according to claim 1, wherein the control system compares the measured wind sensor input to a lookup table stored on the memory system that has wind speed ranges and corresponding predetermined power outputs; and
wherein the control system compares the measured wind sensor input to the lookup table to thereby determine if the measured wind speed is within a wind speed range and then controls the electric motor to adjust the power output to the corresponding predetermined power output such that the motor assists the operator in propelling the bicycle.

6. The bicycle according to claim 1, wherein the wind sensor is a first wind sensor that generates a first measured wind sensor input and further comprising a second wind sensor configured to sense winds acting on the bicycle and generate a second measured wind sensor input;
wherein the first wind sensor is positioned at a front of the bicycle to thereby sense headwinds and the second wind sensor is positioned at an opposite rear of the bicycle to thereby sense tailwinds; and
wherein the control system receives the first measured wind sensor input and the second measured wind sensor input and controls the power output of the electric motor based on the wind speeds that correspond to the first measured wind sensor input and the second measured wind sensor input.

7. The bicycle according to claim 6, wherein the first wind sensor input corresponds to a measured headwind speed acting on the bicycle and the second measured wind sensor input corresponds to a measured tailwind speed, and wherein the control system is configured to compare the measured headwind speed to the measured tailwind speed and further control the power output of the electric motor based on the greater of the measured headwind speed and the measured tailwind speed.

8. A vehicle for use by an operator, comprising:
a frame having a front wheel and a rear wheel rotatably coupled thereto;
an electric motor coupled to the frame and configured to receive electrical energy from an energy storage device and provide a power output to drive one of the front or back wheels to propel the vehicle;
a wind sensor configured to sense winds acting on the vehicle and generate a measured wind sensor input; and
a control system operable to control a power output of the electric motor, wherein the control system receives the measured wind sensor input and controls the power output of the electric motor based at least in part on the measured wind sensor input.

9. The vehicle according to claim 8, wherein:
when the measured wind sensor input corresponds to headwinds acting on the vehicle, the control system controls the electric motor to thereby increase the power output of the electric motor; and
when the measured wind sensor input corresponds to tailwinds acting on the vehicle, the control system controls the electric motor to thereby decrease the power output of the electric motor.

10. The vehicle according to claim 8, wherein the control system sends a pulse width modulation (PWM) output to the electric motor based at least in part on the wind sensor input to thereby control the power output of the motor.

11. The vehicle according to claim 8, wherein the control system compares the measured wind sensor input to a threshold wind speed stored on a memory system of the control system such that:
when the control system determines that the measured wind speed is greater than the threshold wind speed, the control system controls the electric motor to increase the power output and assist the operator in propelling the vehicle; and
when the control system determines that the measured wind speed is less than the threshold wind speed, the control system controls the electric motor to decrease the power output and thereby increase power efficiency of the vehicle.

12. The vehicle according to claim 8, wherein the wind sensor is a first wind sensor that generated a first measured wind sensor input and further comprising a second wind sensor configured to sense winds acting on the vehicle and generate a second measured wind sensor input;
wherein the first wind sensor is positioned at a front of the vehicle to thereby sense headwinds and the second wind sensor is positioned at an opposite rear of the vehicle to thereby sense tailwinds; and
wherein the control system receives the first wind sensor input and the second wind sensor input and controls the power output of the electric motor based upon the first and second wind sensor inputs.

13. A method for controlling an electric motor on a vehicle designed to be used by an operator, the method comprising:
providing a control system operable to control a power output of the electric motor of the vehicle;
receiving, via an operator input device, a speed setting input at the control system from the operator of the vehicle that corresponds to a desired speed of the vehicle;
sensing mass of the operator and generating a measured mass sensor input that is sent to a control system;
sensing wind acting on the vehicle and generating a measured wind sensor input that is sent to the control system;
processing, with the control system, the measured mass sensor input and the measured wind sensor input to determine a desired power output of the motor to maintain the vehicle at the desired speed of the vehicle inputted into the operator input device; and
operating the motor, with the control system, at the desired power output.

14. The method according to claim 13, wherein the control system generates a pulse width modulation (PWM) power output signal to control the power output of the electric motor.

15. The method according to claim 13, wherein the control system utilizes an algorithm stored on a memory system to determine the desired power output of the electric motor based on the measured mass sensor input and the measured wind sensor input.

16. The method according to claim 15, wherein the algorithm applies predetermined coefficients to each of the measured mass sensor input and the measured wind sensor inputs when determining the desired power output of the electric motor.

17. The method according to claim 13, wherein the processing of the measured mass sensor input and the measured wind sensor input includes the control system comparing the measured mass sensor input and the measured wind sensor input to a lookup table stored on a memory system, wherein the lookup table has predetermined mass ranges and predetermined wind speed ranges that correspond to predetermined power outputs of the motor; and
wherein the control system compares the measured mass sensor input and the measured wind sensor input to the lookup table to thereby determine a corresponding predetermined power output of the motor.

18. The method according to claim 13, further comprising:
sensing cadence and generating a measured cadence sensor input that is sent to the control system; and
processing, with the control system, the measured cadence input with the measured mass sensor input and the measured wind sensor input to determine the desired power output for controlling the electric motor.

19. A bicycle for use by an operator, comprising:
a frame having a front wheel and a rear wheel rotatably coupled thereto;
a manual drive system with a pedal and crank assembly that the operator engages to thereby rotate rear wheel and propel the bicycle;
an electric motor coupled to the frame and configured to receive electrical energy from an energy storage device and drive at least one of the wheels to thereby assist the operator in propelling the bicycle or resist rotation of at least one of the wheels to thereby increase resistance the operator experiences while pedaling the pedal and crank assembly;
a mass sensor configured to sense a mass of the operator and generate a measured mass sensor input;
a cadence sensor configured to sense a cadence of the pedal and crank assembly and generate a measured cadence input;
an operator input device configured to receive an operator input from the operator that corresponds to a desired calorie expenditure; and
a control system that receives the measured mass sensor input, the measured cadence input, and the operator input and determines a power output of the electric motor to match the desired calorie expenditure of the operator.

20. The bicycle according to claim 19, wherein the control system controls the electric motor over time to vary the power output of the electric motor and thereby assist or resist propulsion of the bicycle such that calories expended by the operator over time is equal to the desired calorie expenditure of the operator.
